(19) United States
(12) Patent Application Publication
(10) Pub. No.: US 2015/0122556 A1
(43) Pub. Date: May 7, 2015

(54) SEAT APPARATUS FOR VEHICLE

(71) Applicant: Aisin Seiki Kabushiki Kaisha, Kariya-shi (JP)

(72) Inventors: Isao Honda, Chiryu-shi (JP); Yoshiaki Tomatsu, Toyoake-shi (JP); Yusuke Takahashi, Toyota-shi (JP); Tomomi Tomizawa, Nisshin-shi (JP)

(73) Assignee: Aisin Seiki Kabushiki Kaisha, Kariya-shi (JP)

(21) Appl. No.: 14/533,242

(22) Filed: Nov. 5, 2014

(30) Foreign Application Priority Data
Nov. 7, 2013 (JP) 2013-230805

(51) Int. Cl. B60N 2/42; G01G 19/08; B60N 2/00

(52) U.S. Cl. CPC B60N 2/42; B60N 2/002; G01G 19/08
USPC 177/136

(57) ABSTRACT

A seat apparatus for a vehicle includes a load detection device measuring a load applied to a seat, an offset amount detection portion adding an offset amount being offset from zero, the offset amount of the load detection device occurred by a collision of the vehicle to a value stored as an offset amount occurred before the collision of the vehicle, the offset amount detection portion storing the offset amount occurred by the collision of the vehicle and the offset amount occurred before the collision of the vehicle as the offset amount in a case where a collision load value occurred by the collision of the vehicle and detected by the load detection device exceeds a predetermined value, and a correction portion correcting a load value detected by the load detection device on the basis of the offset amount stored in the offset amount detection portion.

### CROSS REFERENCE TO RELATED APPLICATIONS

This application is based on and claims priority under 35 U.S.C. §119 to Japanese Patent Application 2013-230805, filed on Nov. 7, 2013, the entire content of which is incorporated herein by reference.

### TECHNICAL FIELD

This disclosure generally relates to a seat apparatus for a vehicle.

### BACKGROUND DISCUSSION

A known automobile is provided with a seat belt or an airbag as an equipment to secure safety of a passenger. The known automobile includes a function which adjusts a speed of the airbag for deployment and a gas amount of the airbag for deployment and adjusts a pretention of the seat belt by determining whether a passenger is an adult, an infant or a child in accordance with a weight of a passenger to enhance the performance of the seat belt and the airbag. From an aspect of the security of a passenger, it is extremely important to precisely determine a load of a passenger by detecting the weight thereof.

Generally, load sensors (load cells) are placed at four corner positions of a seat frame as an apparatus for detecting the weight of a passenger. By adding the load applied to the load sensors in a longitudinal direction together, the weight of a passenger may be generally obtained. However, the load sensor is configured with a strain gauge affixed to a strain body which bends when the load is applied, and outputs voltage signals which change in response to a changing amount of a resistance value associated with flexural deformation of the strain body in response to the load. The strain body is designed to have intensity high enough to measure the weight of a passenger sensitively and may be abnormally deformed when a large impact is applied to the strain body due to, for example, a collision of the vehicle because an excessive load is applied to the strain body. In those cases, because the detection criteria of the load sensor may include discrepancies, the load sensor cannot measure the weight of a passenger precisely.

A passenger weight measuring device is disclosed in JP4267836B (hereinafter referred to as Patent reference 1). As disclosed in Patent reference 1, the passenger weight measuring device includes a load detection means detecting a load in response to an acceleration velocity applied to a passenger and a seat in response to, for example, a weight of a passenger and a collision of a vehicle. The passenger weight measuring device further includes an abnormal load detection means outputting an abnormal load signal in a case where the abnormal load which is out of a preset load detection range is detected by the load detection means. Accordingly, even if the vehicle has a collision at a low speed with a passenger of higher weight (which is in a case where the abnormal load is applied to the strain body), the weight measuring device precisely determines whether an abnormal load is applied to the vehicle and terminates the control for deploying the airbag in accordance with the weight of a passenger.

A vehicle impact determination device is disclosed in JP2011-43454A (hereinafter referred to as Patent reference 2). The vehicle impact determination device determines that an impact is applied to a vehicle in a tensile direction in a case where a load which is equal to or higher than a predetermined value is detected within a predetermined time after a compression load which is equal to or higher than the predetermined value is detected at a position close to a seat for the vehicle. In a case where the impact is applied to the vehicle due to, for example, a collision of the vehicle, the vehicle impact determination device determines, for example, the impact in response to a phenomenon in which a compression load and a tensile load are applied alternately and consecutively within a predetermined time at a portion close to the seating portion of the seat for the vehicle. The vehicle impact determination device includes an impact alert means for notifying a passenger of the vehicle that the vehicle is impacted when determining, for example, the collision of the vehicle. The passenger weight measuring device disclosed in Patent reference 1 and the vehicle impact determination device disclosed in Patent reference 2 prevent relevant devices which activates in response to an inaccurate detection from operating wrongly in a case where the load detection device may possibly detect an inaccurate value due to the collision of the vehicle.

However, when a passenger parallel parks a vehicle in Europe, a vehicle on a passenger may repeatedly collide with vehicles parked in a front-rear direction to secure a parking space. Usually, in those circumstances, a passenger distinction performance of the load sensor is not influenced because of a minor collision of the vehicle.

However, in those circumstances, the passenger weight measuring device disclosed in Patent reference 1 and the vehicle impact determination device disclosed in Patent reference 2 may indicate an alert (impact influence alert) by detecting the minor collision of the vehicle and may increase a frequency to have a vehicle check-up at a dealer or at a maintenance shop of the vehicle to deal with the alert.

A need thus exists for a seat apparatus for a vehicle which is not susceptible to the drawback mentioned above.

### SUMMARY

According to an aspect of this disclosure, a seat apparatus for a vehicle includes a seat, an attachment member configured to be provided on a floor of the vehicle, a fixing member provided at the seat to fix the seat to the attachment member, a load detection device interposed between the fixing member and the attachment member, the load detection device measuring a load applied to the seat to distinguish an existence of a passenger and a type of a passenger, an offset amount detection portion adding an offset amount being offset from zero, the offset amount of the load detection device occurred by a collision of the vehicle, to a value stored as an offset amount being offset from zero, the offset amount of the load detection device occurred before the collision of the vehicle, the offset amount detection portion storing the offset amount being offset from zero, the offset amount of the load detection device occurred by the collision of the vehicle and the value stored as the offset amount being offset from zero, the offset amount of the load detection device occurred before the collision of the vehicle as the offset amount being offset from zero, the offset amount of the load detection device, in a case where a collision load value occurred by the collision of the vehicle and detected by the load detection device exceeds a predetermined value, and a correction portion correcting a load value detected by the load detection device on the basis of the offset amount being offset from zero, the offset amount of the load detection device stored in the offset amount detection portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a view of a seat apparatus for a vehicle placed at a seat according to an embodiment disclosed here;

FIG. 2 is a view of the seat apparatus for the vehicle to which a seat belt is attached;

FIG. 3 is a block diagram schematically showing a control system of the embodiment;

FIG. 4 is a graph showing a relationship between a collision load value and the corresponding offset amount being offset from zero per sensor after a collision of the vehicle;

FIG. 5 is a graph showing a relationship between the total collision load value of front and rear load values obtained by front and rear load sensors and the corresponding offset amount being offset from zero;

FIG. 6 is a graph showing an example of a detection of the collision load detected by a load detection device;

FIG. 7 is a map showing a relationship between an inclination angle of the vehicle and the offset amount being offset from zero, the offset amount of the load detection device in response to the inclination angle;

FIG. 8 is a graph showing an example of a detection of the large collision load value; and

FIG. 9 is a flowchart showing a process for obtaining the offset amount being offset from zero, the offset amount of the load detection device in a case where the collision load value is detected.

### DETAILED DESCRIPTION

A first embodiment of a load detection device 10 of a seat apparatus 100 for a vehicle detecting a load of a passenger seated in a seat 1 will be explained with reference of the drawings. Hereinafter, a front-rear direction corresponds to a front-rear direction of the vehicle when a passenger is seated in a seat 1. A right-left direction corresponds to a right-left direction of the vehicle when a passenger is seated in the seat 1. An upper-lower direction corresponds to an upper-lower direction of the vehicle when a passenger is seated in the seat 1. According to the embodiment, the vehicle corresponds to a vehicle with left-hand steering wheel and the load detection device 10 determines an existence of a passenger seated in a seat of a passenger.

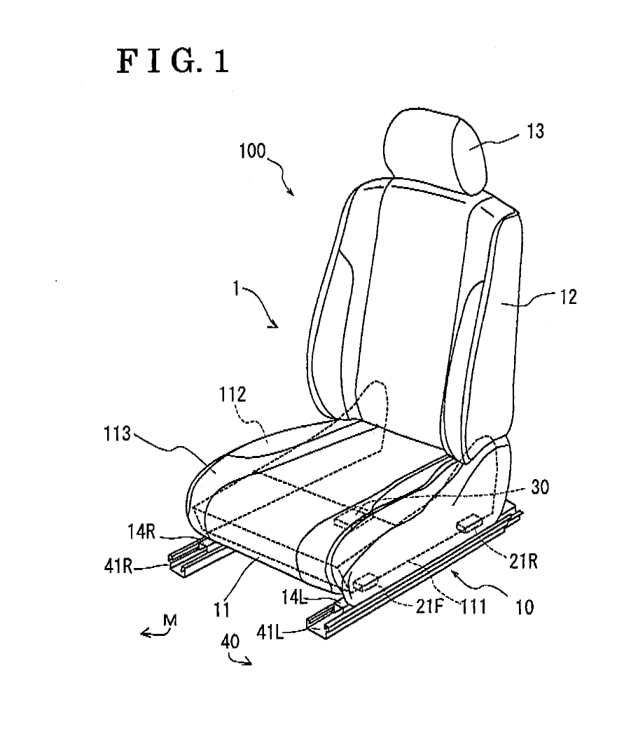

As shown in FIG. 1, the seat 1 which corresponds to the seat of a passenger is provided with a seat cushion 11 (i.e., serving as a seat) in which a passenger is seated, and a seatback 12 mounted to a rear end portion of the seat cushion 11 so as to be rotatable in the front-rear direction. The seatback 12 serves as a backrest for a passenger. A headrest 13 is mounted to an upper end of the seatback 12 to support a head of a passenger.

The seat cushion 11 is provided with a seat frame 111 (i.e., serving as a fixing member), a pad member 112 which is positioned on the seat frame 111, and a cover 113 covering a surface of the pad member 112. A right-left pair of upper rails 14R, 14L (i.e., serving as attachment members) is mounted to a lower surface of the seat frame 111. The upper rails 14R, 14L movably engage with a pair of lower rails 41R, 41L (i.e., serving as attachment members), respectively, in the front-rear direction. The pair of lower rails 41R, 41L is fixed on a floor 40 of the vehicle. Accordingly, the seat 1 is formed so as to be movable on the floor 40 of the vehicle in the front-rear direction and be fixed at a position where a passenger desires.

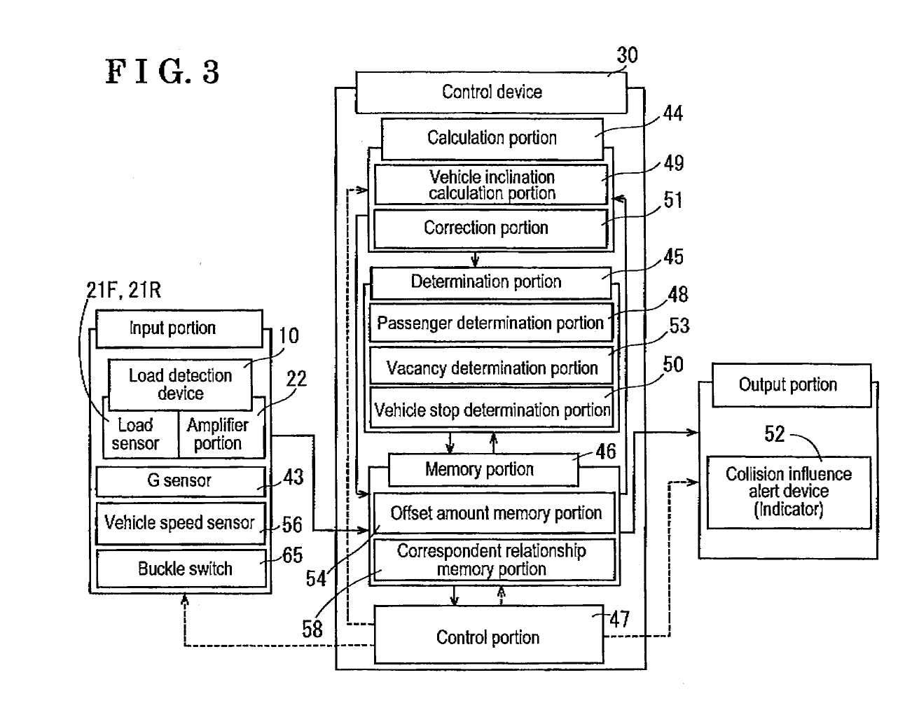

Next, the construction of the load detection device 10 will be explained. As shown in FIG. 3, the load detection device 10 includes a front load sensor 21F (i.e., serving as a load detection device), a rear load sensor 21R (i.e., serving as a load detection device) and an amplifier portion 22 which amplifies a detected strain value.

As shown in FIG. 1, the front and rear load sensors 21F, 21R are positioned between the seat frame 111 and the left-side upper rail 14L to be spaced apart from each other at a predetermined distance in the front-rear direction. The front load sensor 21F is placed at a front portion relative to a center of the seat cushion 11 in the front-rear direction, and the rear load sensor 21R is placed at a rear portion relative to a center of the seat cushion 11 in the front-rear direction. The front and rear load sensors 21F, 21R correspond to known load sensors.

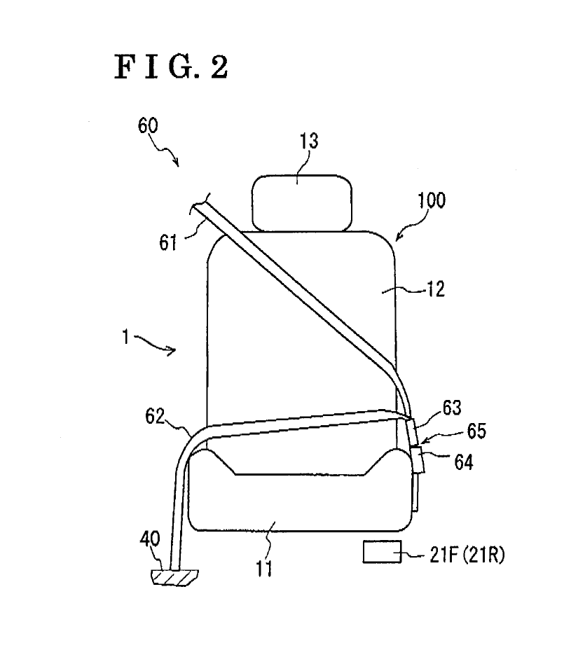

The front load sensor 21F is placed between a front portion of the seat frame 111 and the left-side upper rail 14L and detects a front load value Ff applied to a front left-side portion of the seat cushion 11. Similarly, the rear load sensor 21R is placed between a rear portion of the seat frame 111 and the left-side upper rail 14L and is placed close to a buckle 64 (see FIG. 2) which is supported by the seat 1. The rear load sensor 21R detects a rear load value Rf applied to a rear left-side portion of the seat cushion 11.

The front and rear load sensors 21F, 21R output positive detection signals in a case where a load is applied to the seat cushion 11 downwardly when a passenger is seated in the seat 1. The front and rear load sensors 21F, 21R output negative detection signals in a case where a load is applied to the seat cushion 11 upwardly when a passenger is seated in the seat 1. The front and rear load sensors 21F, 21R are zero-adjusted so that each of the load values Ff, Rf remains zero in a state where the vehicle is shipped from a factory.

The load detection device 10 is connected to a control device 30 which is connected by, for example, an indicator 52 (serving as a collision influence alert device) which serves as an output portion.

The control device 30 includes an analog-digital converter or an A/D converter, a calculation portion 44 (i.e., serving as an offset amount detection portion), a memory portion 46, a determination portion 45, and a control portion 47. The A/D converter converts detected analog signals transmitted from the front and rear load sensors 21F, 21R into digital signals. The calculation portion 44 receives detected signals transmitted from the front and rear load sensors 21F, 21R, from a gravity sensor 43, or a G sensor 43 (i.e., serving as an inclination angle detection device), and from a buckle switch 65. The memory portion 46 stores data. The determination portion 45 performs, for example, passenger determination. The control portion 47 controls an input portion, an output portion and the calculation portion 44. The calculation portion 44 includes a vehicle inclination calculation portion 49 calculating the inclination, or the tilt of the vehicle M in a lateral direction based on the detected signals transmitted from the G sensor 43, and a correction portion 51 applying zero correction to an offset amount (i.e., the offset amount being offset from zero) obtained after the collision of the vehicle. An inclination angle detection device is configured with the G sensor 43.

The determination portion 45 includes a passenger determination portion 48, a vacancy determination portion 53 and a vehicle stop determination portion 50. The passenger determination portion 48 determines the existence of a passenger and a type of a passenger using a total front-rear load value (Ff+Rf) which is obtained by adding the front load value Ff detected by the front load sensor 21F and the rear load value Rf detected by the rear load sensor 21R together. The vacancy determination portion 53 determines whether the seat 1 is in an unoccupied state by a passenger or an object. The vehicle stop determination portion 50 determines whether the vehicle is in a stopped state based on the detected signals transmitted from a vehicle speed sensor 56.

As shown in FIG. 3, the memory portion 46 includes an offset amount memory portion 54 (i.e., offset amount detection portion) which stores data of the offset amount being offset from zero, the offset amount detected before a collision of the vehicle, and a correspondent relationship memory portion 58 which shows the relationship between the collision load value and the offset amount being offset from zero after the collision of the vehicle. An offset amount detection portion is configured with the calculation portion 44 and the offset amount memory portion 54. Hereinafter, the offset amount being offset from zero, the offset amount of the load detection device 10 is referred to as an offset amount.

The control device 30 receives signals transmitted from the load detection device 10 and the buckle switch 65 and determines whether the seat 1 is occupied by a passenger or is unoccupied, and whether a passenger is an adult, an infant, or a child by determination processes operated by the passenger determination portion 48. Then, the control portion 47 controls an indicator lamp for the airbag.

As FIG. 2 shows a front view of the seat device 10 for the vehicle, a seat belt device 60 (a seat belt) includes a shoulder strap 61, a lap strap 62 and the buckle 64. A first end portion of the shoulder strap 61 and a first end portion of the lap strap 62 are connected with each other by a tongue plate 63. The buckle 64 forms the buckle switch 65 by being connected to and disconnected from the tongue plate 63.

A retractor (a winding device) is accommodated inside a pillar portion which is placed at the right-side of the seat apparatus 100 for the vehicle. An upper end of the shoulder strap 61 is connected to the retractor and the shoulder strap 61 can be pulled out against a winding force of the retractor.

A second end of the lap strap 62 is fixed to the vehicle floor 40 at the right-side of the seat apparatus 100 for the vehicle. The buckle 64 is supported at the left-side rear portion of the seat apparatus 100 for the vehicle and includes an opening which opens upward to be inserted by the tongue plate 63. The tongue plate 63 is connected to the shoulder strap 61 and the lap strap 62 and inserts into the opening of the buckle 64 to engage therewith and fixed thereto.

Because the buckle 64 is placed at the same side of the seat apparatus 100 for the vehicle where the front and rear load sensors 21F, 21R are placed, the load detection device 10 can detect not only the weight of a passenger seated in the seat 1 but also the load applied to the buckle 64 downwardly when a passenger wears the seat belt device 60 and the load applied to the buckle 64 upwardly when the seat belt is pulled when a passenger wears the seat belt device 60.

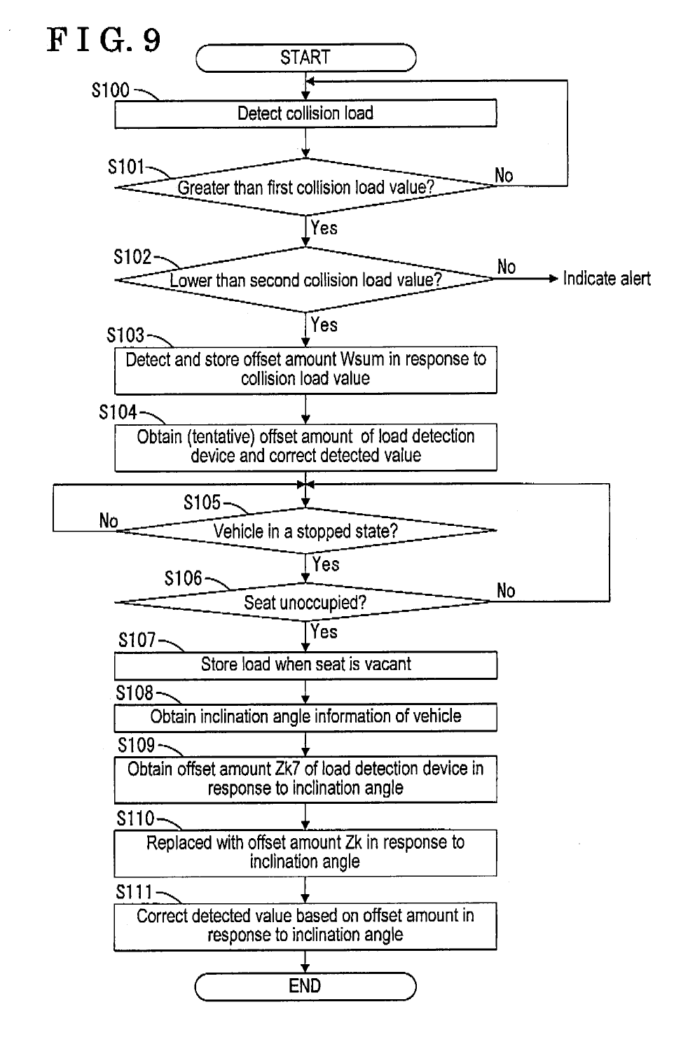

Next, according to the above-configured seat apparatus 100 for the vehicle, an existence of an influence on the passenger determination performance of the load detection device 10 by the collision of the vehicle M will be explained with reference to the following determination process based on a flowchart shown in FIG. 9.

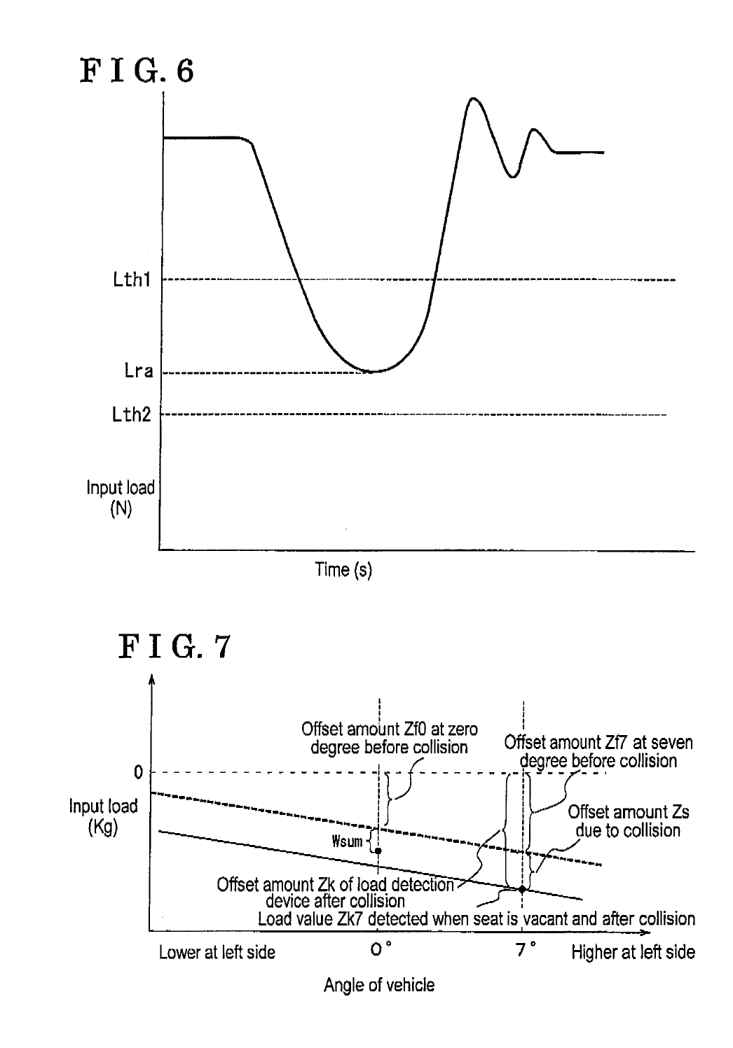

For example, in a case where the rear load sensor 21R placed at the rear of the seat 1 (seat cushion) for the vehicle detects the collision load (a negative value is detected) in the detachment direction of the attachment members (the left-side upper rail 14L and the left-side lower rail 41L) and the fixing member (the seat frame 111) at the time of the front collision of the vehicle (step S100), the program proceeds to step S101 and the control device 30 determines whether the detected collision load value is greater than a predetermined first collision load value Lth1 (i.e., serving as a predetermined value) (step S101). Because the detected collision load value is indicated with a positive value or a negative value, or with a plus or a minus sign in accordance with a direction to which the load is applied, the detected collision load value is basically determined using an absolute value. Hereinafter, any detected collision load values in the embodiment will be determined using the absolute values. The rear load sensor 21R detects the negative load value in the detachment direction of the attachment members (the left-side upper rail 14L and the left-side lower rail 41L) and the fixing member (the seat frame 111) as a collision load in the case of the front collision of the vehicle M. The front sensor 21F detects the negative bad value in the detachment direction of the attachment members (the left-side upper rail 14L and the left-side lower rail 41L) and the fixing member (the seat frame 111) as a collision load in the case of the rear collision of the vehicle M. The data of the first collision load value Lth1 is prestored in the memory portion 46 of the control device 30 as a first threshold value of the collision load value which may influence on the passenger determination performance of the load detection device 10. In the case of the collision in which a load lower than the predetermined first collision load value Lth1 is detected, the load is considered to be uninfluential on the offset amount (i.e., the offset amount being offset from zero, the offset amount of the load detection device 10) and is disregarded. According to the embodiment, as shown in FIG. 6, for example, a collision load value Lra is detected.

In the embodiment, the control device 30 determines that the detected collision load value Lra is greater than the predetermined collision load value Lth1, and the program proceeds to step S102. In a case where the collision load value Lra is lower than the predetermined first collision load value Lth1, the program returns to step S100 and waits until a next collision load is detected.

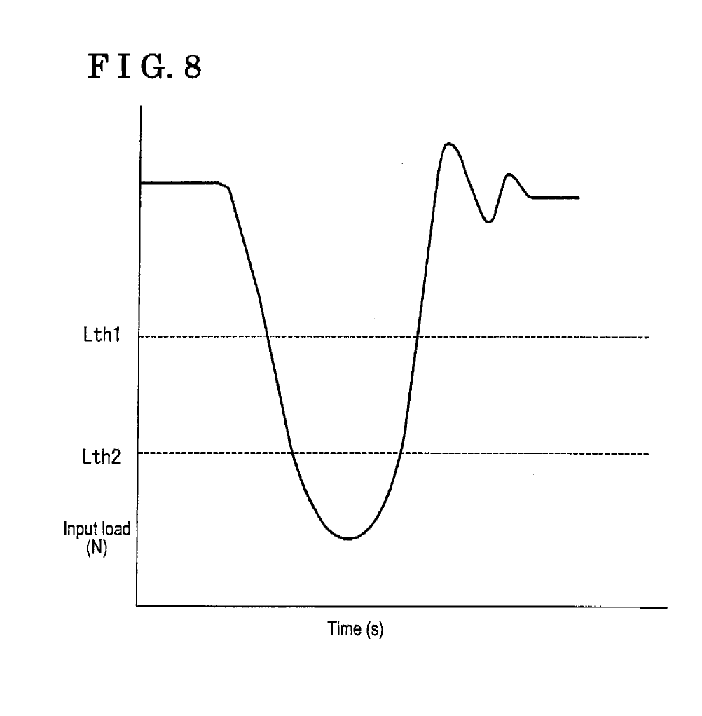

In step S102, the control device 30 determines whether the detected collision load value Lra is lower than a second collision load value Lth2. For example, as shown in FIG. 8, in a case where the detected collision load value Lra is larger than the second collision load value Lth2, the alert is given promptly by, for example, the indicator 52. Because an impact of the collision is regarded to be too large to correct the offset amount (i.e., the offset amount being offset from zero, the offset amount of the load detection device 10), the process for correcting the offset amount is skipped. Then, the alert indicating the influence on the passenger determination performance due to the collision of the vehicle is given by, for example, the indicator 52 which urges a passenger for early vehicle check-up.

In step S102, in a case where the control device 30 determines that the detected collision load value Lra is lower than the second collision load value Lth2, the program proceeds to step S103.

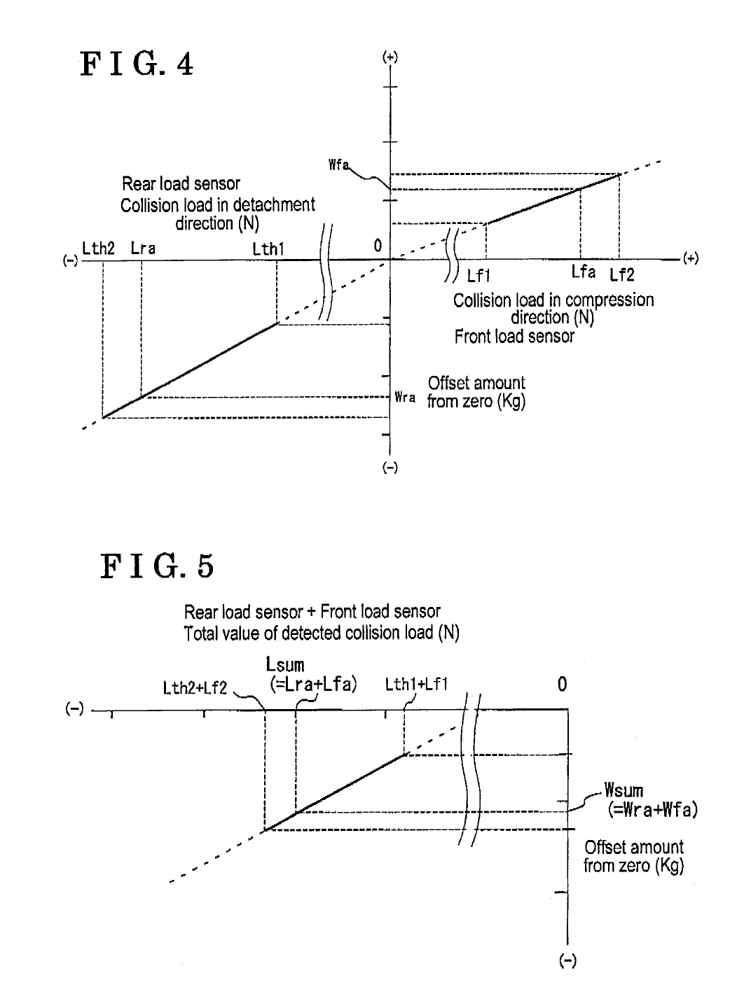

In step S103, as shown in FIGS. 4 and 5, the control device 30 detects the offset amount (i.e., the offset amount being offset from zero, the offset amount of the load detection device 10) due to the collision using a map stored in the correspondent relationship memory portion 58 and showing the relationship between the collision load value and the offset amount which corresponds to the collision load value. The correspondent relationship memory portion 58 prestores that the front load sensor 21F detects the collision load value Lf1 (compression load) when the rear load sensor 21R detects the first collision load value Lth1. The correspondent relationship memory portion 58 prestores that the front load sensor 21F detects the second collision load value Lf2 (compression load) when the rear load sensor 21R detects the second collision load value Lth2.

For example, as shown in FIG. 4, in a case where the rear load sensor 21R detects the collision load value Lra, the front load sensor 21F detects the impact load value Lfa. Thus, a total collision load value Lsum (=Lra+Lfa) which is obtained by adding the collision load values detected by the rear load sensor 21R and the front load sensor 21F together is detected. Then, the rear load sensor 21R detects an offset amount Wra (i.e., the offset amount being offset from zero, the offset amount of the load detection device 10) and the front load sensor 21F detects an offset amount Wfa (i.e., the offset amount being offset from zero, the offset amount of the load detection device 10) due to the collision of the vehicle.

FIG. 5 shows the total collision load value of front and rear load values Ff, Rf detected by front and rear load sensors 21F, 21R. For example, in a case where the total load value Lsum, which corresponds to the total value of the rear load value Rf and the front load value Ff detected by the rear load sensor 21R and the front load sensor 21F and is a negative value, is detected, an offset amount Wsum (=Wra+Wfa) due to the collision of the vehicle is detected. In the example, the negative offset amount Wsum is detected.

Next, the program proceeds to step S104 and the offset amount is obtained by adding the total offset amount Wsum detected, or determined, by the correspondent relationship between the collision load value and the offset amount, the offset amount due to the collision of the vehicle to an offset amount Zf0 (i.e., serving as a value) at the zero degree of the vehicle inclination angle, or tilt angle relative to a predetermined reference surface (which corresponds to a horizontal surface), the offset amount Zf0 detected before the collision of the vehicle as shown in FIG. 7. Accordingly, the offset amount is obtained, and the zero correction (tentative zero correction) is applied to the obtained offset amount. A load value will be detected based on the corrected value in the future detection.

FIGS. 4 and 5 show maps illustrating the relationship between the collision load value and the offset amount (i.e., the offset amount being offset from zero, the offset amount of the load detection device 10) in response to the collision load value. Because each of the maps does not have a factor of the inclination angle of the vehicle M, the inclination angle corresponds to zero.

When the collisions are repeated for plural times, the offset amount is detected for each collision using the map showing the relationship between the collision load value and the offset amount in response to the collision load value. Then, the offset amount can be obtained by accumulating the detected plural offset amounts and adding the accumulated plural offset amounts to the offset amount which is detected before the collision of the vehicle.

Next, in step S105, the control device 30 determines whether the vehicle M is in the stopped state, for example, by detected signals transmitted from the vehicle speed sensor 56. In a case where it is determined that the vehicle is not in the stopped state, the determination whether the vehicle M is in the stopped state is performed repeatedly in step S105.

In a case where it is determined that the vehicle M is in the stopped state, the program proceeds to step S106 and determines whether a passenger is seated in the seat 1. In a case where, for example, the buckle switch 65 is in an off state, or where the load detected by the load detection device 10 is lower than the predetermined threshold value on a continual basis for a predetermined time, it is determined that a passenger is not seated in the seat 1. In a case where it is determined that a passenger is seated in the seat 1, the program returns to step S105, and repeats whether the vehicle is in the stopped state in step S105. In a case where it is determined that a passenger is not seated in the seat 1, the program proceeds to step S107 and stores the load value detected by the load detection device 10 when the seat 1 is vacant and the vehicle is in the stopped state to the offset amount memory portion 54. The stored load value is used for obtaining the offset amount (i.e., the offset amount being offset from zero, the offset amount of the load detection device 10) in response to the inclination angle relative to a predetermined reference surface (which corresponds to a horizontal surface) when the inclination angle of the vehicle is obtained (step S107).

Next, the program proceeds to step S108 and obtains information of the inclination angle of the vehicle M which is in the stopped state by the G sensor 43. As shown in FIG. 1, because the front and rear load sensors 21F, 21R are placed at the left-side of the seat 1 in the front-rear direction, the load values detected by the front and rear load sensors 21F, 21R come to be low in a case where the vehicle M is inclined, or tilted in the lateral direction so that the left-side of the seat 1 comes to be higher than the right-side of the seat 1 as shown in FIG. 7, and the load values detected by the front and rear load sensors 21F, 21R come to be high in a case where the vehicle M is inclined, or tilted in the lateral direction so that the left-side of the seat 1 comes to be lower than the right-side of the seat 1 as shown in FIG. 7. Thus, as shown in FIG. 7, for example, the offset amounts Zf0, Zf7 (i.e., serving as values) in response to the inclination angle of the vehicle M are obtained in a state where the seat 1 is vacant and before the collision of the vehicle M. The obtained offset amounts Zf0, Zf7 are stored in the offset amount memory portion 54 (the offset amount detection portion) in the map.

The prestored offset amount in response to the inclination angle of the vehicle M in a state where the seat 1 is vacant and before the collision of the vehicle M corresponds to a total detected load value (Ff+Rf) detected by the front and rear load sensors 21F, 21R when the seat 1 is vacant. A detected load value (a difference of the load value from 0 kg) including the weights of, for example, the seat cushion 11 serving as the seat, the seatback 12 and frames corresponds to the offset amount (i.e., the offset amount being offset from zero, the offset amount of the load detection device 10) when the seat 1 is vacant. According to the embodiment, the offset amount Zs due to the collision of the vehicle does not include the weights of, for example, the seat cushion 11, the seatback 12 and the frames in a state where the seat 1 is vacant and after the collision of the vehicle.

Next, the program proceeds to step S109 and obtains the offset amount in response to the inclination angle, or the tilt angle of the vehicle M. The offset amounts Zf0, Zf7 detected in response to the inclination angle of the vehicle M stored in the offset amount memory portion 54, the offset amounts Zf0, Zf7 detected in a state where the seat 1 is vacant and before the collision of the vehicle M have the same degree of the influence on the detected load value in response to the inclination angle of the vehicle M as the offset amount Zk in response to the inclination angle of the vehicle M in a state where the seat 1 is vacant and after the collision of the vehicle. Accordingly, as shown in FIG. 7, a line illustrating the offset amounts Zf0, Zf7 and a line illustrating the offset amount Zk are shown in parallel to each other. Because the load value is detected in step S107, it is confirmed that the vehicle inclination angle corresponds to 7 degrees in steps S108 and S109. Thus, for example, the load detected by the load detection device 10 with the inclination angle of 7 degrees in a state where the seat 1 is vacant and at a time of the collision of the vehicle M is detected as the offset amount Zk7. Accordingly, the offset amount Zk (including Zk7) in response to other inclination angles of the vehicle M when the seat 1 is vacant may be obtained.

Next, the program proceeds to step S110 and replaces an offset amount Zf (i.e., serving as a value) in a state where the seat 1 is vacant and before the collision of the vehicle with an offset amount Zk (i.e., the offset amount being offset from zero, the offset amount of the load detection device 10) in response to the inclination angle of the vehicle M. According to the embodiment, the offset amount (Zf0+Wsum) based on the offset amount Wsum caused by the collision of the vehicle and obtained, in steps S103, S104, from the correspondent relationship between the collision load and the offset amount due to the collision of the vehicle is cancelled. Then, the offset amount (Zf0 Wsum) is replaced with the offset amount Zk which is in response to the inclination angle in a state where the seat 1 is vacant and after the collision of the vehicle M and is then stored in the offset amount memory portion 54.

Next, the program proceeds to step S111 and applies the zero correction of the load value detected by the load detection device 10 to the offset amount Zk which is in response to the inclination angle in a state where the seat 1 is vacant and after the collision of the vehicle M. Then, the detected load is obtained based on the corrected offset amount.

As above, by obtaining the offset amount Zk using the load value detected by the load detection device 10 in a state where the seat 1 is vacant and after the collision of the vehicle, and by applying the zero correction to the obtained offset amount after the collision of the vehicle, the accuracy of the zero correction is enhanced to enable the precise passenger determination. Thus, an operator of the vehicle M may decrease the frequency to ask a dealer or a maintenance shop for the vehicle check-up.

As is clear from the above explanation, according to the seat apparatus 100 for the vehicle of the embodiment, in a case where the collision load value occurred by the collision of the vehicle M is detected, the offset amount (Zs or Wsum) which occurs the difference in the detected load value detected by the load detection device 10 and occurred by the collision of the vehicle M is obtained. Then, the obtained offset amount (Zs or Wsum) due to the collision of the vehicle M is replaced by adding the offset amount Zf0 which is detected before the collision of the vehicle M to the obtained offset amount (Zs or Wsum). Then, the zero correction is applied to the replaced offset amount and the correction portion 51 corrects the load detected by the load detection device 10. Thus, an operator of the vehicle M does not have to take time and labor to ask a dealer or a maintenance shop for the vehicle check-up everytime the vehicle has the collision.

Generally, the load of a passenger detected by the load detection device 10 is detected as a load in the compression direction which corresponds to a direction where the left-side upper rail 14L and the seat frame 111 come close to each other. Accordingly, the load value can be detected clearly, easily and securely by detecting the collision load value in a detachment direction of the left-side upper rail 14L and the seat frame 11, the detachment direction which is a reverse direction where the load of a passenger is detected.

Further, by detecting the offset amount (Wsum) due to the collision of the vehicle in response to the relationship between the collision load value and the offset amount prestored in the correspondent relationship memory portion 58, the load value detected by the load detection device 10 is promptly corrected by obtaining the offset amount caused by the collision of the vehicle M easily and promptly.

When the vacancy determination portion 53 determines that the seat 1 is vacant, the offset amount memory portion 54 replaces the prestored offset amount (for example, Zf0) in a state where the seat 1 is vacant with, for example, the load value Zk7 detected by the load detection device 10 and stores the load value Zk7 as the offset amount Zk. According to the embodiment, the offset amount (Zf0+Wsum) is obtained by adding the offset amount Wsum caused by the collision of the vehicle and obtained in response to the relationship between the collision load value and the offset amount in response to the collision load value stored in the correspondent relationship memory portion 58 to the offset amount Zf0 which is obtained before the collision of the vehicle. Then, the obtained offset amount (Zf0+Wsum) is replaced with the load value Zk7 detected by the load detection device 10 when it is determined that the seat 1 is vacant.

As above, the offset amount (Zf0+Wsum) obtained in response to the relationship between the collision load value and the offset amount is replaced with the offset amount Zk based on the load value detected by the load detection device 10 when the seat 1 is vacant. Then, the load value detected by the load detection device 10 is corrected based on the replaced offset amount Zk. Accordingly, the passenger determination is precisely performed based on the load value detected by the load detection device 10 after the collision of the vehicle.

When the vehicle stop determination portion 50 determines that the vehicle M is in the stopped state (it is premised that the seat 1 is vacant), the offset amount memory portion 54 stores the load value detected by the load detection device 10 as the offset amount Zk. Thus, the offset amount (i.e., the offset amount being offset from zero, the offset amount of the load detection device 10) may be detected while excluding disturbance along the operation of the vehicle which influences on the detection accuracy of the offset amount. Because the load value detected by the load detection device 10 is corrected based on the offset amount Zk which is detected accurately by excluding the disturbance, the high-precision passenger determination can be performed based on the load value detected by the load detection device 10 even after the collision of the vehicle.

The vehicle M is not always stopped on a horizontal ground and may be stopped on an inclined, or a tilted ground. For example, according to the embodiment, in a case where the load detection device 10 is placed in the front-rear direction of a center side of the vehicle M, which is right-side of the left-side seat in the front-rear direction, the value detected by the load detection device 10 comes to be higher than a detected value of a flat ground without inclination when the vehicle M is in the stopped state in which the right-side of the vehicle M comes to be lower than the left-side of the vehicle M. On the other hand, the value detected by the load detection device 10 comes to be lower than a detected value of a flat ground without inclination when the vehicle M is in the stopped state in which the left-side of the vehicle M comes to be lower than the right-side of the vehicle M. Because the offset amount is obtained from the load value detected by the load detection device 10 in a state where the seat is vacant, the inclination of the ground where the vacant vehicle M is in the stopped state is influential on the offset load value.

Accordingly, the G sensor 43 detects the inclination angle of the inclined ground on which the vehicle M is in the stopped state and the offset amount memory portion 54 stores the load value detected by the load detection device 10 as the offset amount Zk (for example, Zk7) which is in response to the inclination angle of the ground on which the vehicle M is in the stopped state, the inclination angle relative to a predetermined reference surface (which corresponds to a horizontal surface). Thus, not only a case where the vehicle M is stopped on the horizontal ground but also a case where the vehicle M is stopped on the inclined ground, the offset amount Zk which is in response to the inclination angle of the ground on which the vehicle M is in the stopped state can be detected precisely. Because the load value detected by the load detection device 10 is corrected based on the precisely-detected offset amount Zk, the high-precision passenger determination is performed based on the load value detected by the load detection device 10.

According to the aforementioned embodiment, the collision load value corresponds to higher than the first collision load value Lth1, however does not limited to this, Alternatively, the first collision load value Lth1 may be set appropriately by an examination or an experiment in accordance with the performance of the vehicle or of the load detection device 10. According to the embodiment, the second collision load value Lth2 is set, however, is not always necessary. Only the first collision load value Lth1 can be provided to detect the collision load.

In a case where the offset amount Zs due to the collision of the vehicle M is added to the stored offset amount Zf before the collision of the vehicle M and a total offset amount of the offset amount Zs and the stored offset amount Zf is stored as an offset amount Zk being offset from zero, the formula Zf+Zs=Zk is shown by specifically adding the offset amount Zs to the offset amount Zf, however is not limited to this. For example, in a case where the offset amount Zs due to the collision of the vehicle M includes the load of the seat 1, the value excluding the load of the seat 1 from the offset amount Zs may be added to the stored offset amount Zf which is obtained before the collision of the vehicle to provide the offset amount R.

According to the embodiment, the front load sensor 21F and the rear load sensor 21R are placed to be spaced apart from each other in the front-rear direction of a left portion of the passenger seat of the vehicle, which is the center side of the vehicle, with left-hand steering wheel. Alternatively, the front load sensor and the rear load sensor can be placed to be spaced apart from each other in the front-rear direction of a right portion of the passenger seat of the vehicle, which is the center side of the vehicle, with right-hand steering wheel. The front load sensor and the rear load sensor may be placed to be spaced apart from each other in the front-rear direction of the outer side (window side) of the passenger seat.

Alternatively, the two load sensors may be positioned at the rear portion of the seat 1 in the right-left direction to be spaced apart from each other. In those circumstances, the influence by the inclination of the vehicle M corresponds to the influence by the inclination of the vehicle M in the front-rear direction. In a case where the front portion of the vehicle is inclined downwardly, the detected load is decreased, and in a case where the front portion of the vehicle is inclined upwardly, the detected load is increased.

According to the embodiment, the detected collision load corresponds to the detected load of the load detection device 10 in the detachment direction of the attachment members (upper rail 14L and lower rail 41L) and the fixing member (the seat frame 111), however, is not limited to this. For example, the detected collision load may correspond to a detected load in the compression direction of the of the attachment members (the left-side upper rail 14L and the left-side lower rail 41L) and the fixing member (the seat frame 111), the direction where attachment members (the left-side upper rail 14L and the left-side lower rail 41L) and the fixing member (the seat frame 111) come close to each other.

Constructions of the aforementioned embodiments are not limited to the aforementioned embodiment and various modifications are applied as long as the modifications do not depart from the objective of the disclosure.

According to the aforementioned embodiment, the seat apparatus 100 for the vehicle includes the seat, the attachment member (the right-left pair of upper rails 14L, 14R and the right-left pair of lower rails 41L, 41R) configured to be provided on the floor 40 of the vehicle, the fixing member (the seat frame 111) provided at the seat 1 to fix the seat 1 to the attachment member (the right-left pair of upper rails 14L, 14R and the right-left pair of lower rails 41L, 41R), the load detection device (the load detection device 10, the front load sensor 21F, the rear load sensor 21R) interposed between the fixing member (the seat frame 111) and the attachment member (the right-left pair of upper rails 14L, 14R and the right-left pair of lower rails 41L, 41R), the load detection device (the load detection device 10, the front load sensor 21F, the rear load sensor 21R) measuring the load applied to the seat 1 to distinguish the existence of a passenger and the type of a passenger, the offset amount detection portion (the calculation portion 44, the offset amount memory portion 54) adding the offset amount Wsum, Zs being offset from zero, the offset amount Wsum, Zs of the load detection device (the load detection device 10, the front load sensor 21F, the rear load sensor 21R) occurred by a collision of the vehicle, to the value (the offset amount Zf, Zf0, Zf7) stored as an offset amount being offset from zero, the offset amount of the load detection device (the load detection device 10, the front load sensor 21F, the rear load sensor 21R) occurred before the collision of the vehicle, the offset amount detection portion (the calculation portion 44, the offset amount memory portion 54) storing the offset amount Wsum, Zs being offset from zero, the offset amount Wsum, Zs of the load detection device (the load detection device 10, the front load sensor 21F, the rear load sensor 21R) occurred by the collision of the vehicle and the value (the offset amount Zf, Zf0, Zf7) stored as the offset amount being offset from zero, the offset amount of the load detection device (the load detection device 10, the front load sensor 21F, the rear load sensor 21R) occurred before the collision of the vehicle as the offset amount Zk being offset from zero, the offset amount Zk of the load detection device (the load detection device 10, the front load sensor 21F, the rear load sensor 21R), in a case where the collision load value Lra occurred by the collision of the vehicle and detected by the load detection device (the load detection device 10, the front load sensor 21F, the rear load sensor 21R) exceeds the predetermined value Lth1, and the correction portion 51 correcting the collision load value Lra detected by the load detection device (the load detection device 10, the front load sensor 21F, the rear load sensor 21R) on the basis of the offset amount Zk being offset from zero, the offset amount Zk of the load detection device (the load detection device 10, the front load sensor 21F, the rear load sensor 21R) stored in the offset amount detection portion (the calculation portion 44, the offset amount memory portion 54).

According to the aforementioned embodiment, in a case where the collision load value occurred by the collision of the vehicle M is detected, the offset amount (Zs or Wsum) which occurs the difference in the detection load value detected by the load detection device 10 caused by the collision of the vehicle M is obtained. Then, the obtained offset amount (Zs or Wsum) due to the collision of the vehicle M is added to the stored value which serves as the offset amount Zf0 detected before the collision of the vehicle and is stored as the offset amount (i.e., the offset amount being offset from zero, the offset amount of the load detection device 10). The load value detected by the load detection device 10 is corrected based on the newly stored offset amount.

As above, in a case where the collision load value occurred by the collision of the vehicle M is detected, the offset amount (Zs or Wsum) which occurs the difference in the detected load value detected by the load detection device 10 and occurred by the collision of the vehicle M is obtained. Then, the obtained offset amount (Zs or Wsum) due to the collision of the vehicle M is replaced by adding the offset amount Zf0 which is detected before the collision of the vehicle M to the obtained offset amount (Zs or Wsum). Then, the load value detected by the load detection device 10 is corrected based on the replaced offset amount so that high-precision detection of the load detection device 10 may be easily maintained. Further, an operator of the vehicle M does not have to take time and labor to ask a dealer or a maintenance shop for the vehicle check-up everytime the vehicle has the collision.

According to the aforementioned embodiment, the collision load value Lra that the load detection device (the load detection device 10, the front load sensor 21F, the rear load sensor 21R) detects at the collision of the vehicle corresponds to a load applied in a detachment direction, the detachment direction corresponding to a direction where the attachment member (the right-left pair of upper rails 14L, 14R and the tight-left pair of lower rails 41L, 41R) and the fixing member (the seat frame 111) are separated from each other.

The load of a passenger detected by the load detection device 10 is detected as the load in the compression direction which corresponds to the direction where the left-side upper rail 14L and the seat frame 111 come close to each other. Accordingly, the load value can be detected clearly, easily and securely by detecting the collision load value in the detachment direction of the left-side upper rail 14L and the seat frame 11, the detachment direction which is the reverse direction where the load of a passenger is detected.

According to the aforementioned embodiment, the seat apparatus 100 for the vehicle further includes the correspondent relationship memory portion 58 previously obtaining the relationship between the collision load value Lra detected by the load detection device (the load detection device 10, the front load sensor 21F, the rear load sensor 21R) at a time of the collision of the vehicle and the offset amount Wsum, Zs being offset from zero in response to the collision load value Lra, and the correspondent relationship memory portion 58 storing the relationship thereof. The offset amount detection portion (the calculation portion 44, the offset amount memory portion 54) detects the offset amount Wsum, Zs being offset from zero, the offset amount Wsum, Zs of the load detection device (the load detection device 10, the front load sensor 21F, the rear load sensor 21R) occurred by the collision of the vehicle, in response to the relationship stored in the correspondent relationship memory portion 58, the relationship between the collision load value Lra and the offset amount Wsum, Zs being offset from zero.

Further, by detecting the offset amount (Wsum) due to the collision of the vehicle in response to the relationship between the collision load value and the offset amount prestored in the correspondent relationship memory portion 58, the load value detected by the load detection device 10 is promptly corrected by obtaining the offset amount caused by the collision of the vehicle M easily and promptly.

According to the aforementioned embodiment, the seat apparatus 100 for the vehicle further includes the vacancy determination portion 53 determining whether the seat is in the vacant state where the seat is neither occupied by a passenger nor by an object. The offset amount detection portion (the calculation portion 44, the offset amount memory portion 54) stores the collision load value Lra detected by the load detection device (the load detection device 10, the front load sensor 21F, the rear load sensor 21R) as the offset amount Wsum, Zs being offset from zero, the offset amount Wsum, Zs of the load detection device (the load detection device 10, the front load sensor 21F, the rear load sensor 21R), when the vacancy determination portion 53 determines that the seat 1 is in the vacant state.

When the vacancy determination portion 53 determines that the seat 1 is vacant, the offset amount memory portion 54 replaces the prestored offset amount (for example, Zf0) in a state where the seat 1 is vacant with, for example, the load value Zk7 detected by the load detection device 10 and stores the detected load value Zk7 as the offset amount Zk.

The prestored offset amount which is obtained before the collision of the vehicle (including the offset amount obtained from the correspondent relationship between the collision load value and the offset amount which is obtained before the collision of the vehicle M) is replaced with the offset amount Zk based on the load value detected by the load detection device 10 when the seat 1 is vacant. Then, the load value detected by the load detection device 10 is corrected based on the replaced offset amount Zk. Accordingly, the passenger determination is precisely performed based on the load value detected by the load detection device 10 even after the collision of the vehicle.

According to the aforementioned embodiment, the seat apparatus 100 for the vehicle further includes the vehicle stop determination portion 50 determining whether the vehicle is in a stopped state. The offset amount detection portion (the calculation portion 44, the offset amount memory portion 54) stores collision load value Lra detected by the load detection device (the load detection device 10, the front load sensor 21F, the rear load sensor 21R) as the offset amount Wsum, Zs being offset from zero, the offset amount Wsum, Zs of the load detection device (the load detection device 10, the front load sensor 21F, the rear load sensor 21R) when the vehicle stop determination portion 50 determines that the vehicle is in the stopped state.

When the vehicle stop determination portion 50 determines that the vehicle M is in the stopped state, the offset amount memory portion 54 stores the load value detected by the load detection device 10 as the offset amount Zk. Thus, the offset amount (i.e., the offset amount being offset from zero, the offset amount of the load detection device 10) may be detected while excluding disturbance along the operation of the vehicle which influences on the detection accuracy of the offset amount. Because the load value detected by the load detection device 10 is corrected based on the offset amount Zk which is detected accurately by excluding the disturbance, the high-precision passenger determination can be performed based on the load value detected by the load detection device 10 even after the collision of the vehicle.

According to the aforementioned embodiment, the seat apparatus 100 for the vehicle further includes the inclination angle detection device (the G sensor 43) detecting the inclination angle of the vehicle relative to the predetermined reference surface in a case where the vehicle is in the stopped state. The offset amount detection portion (the calculation portion 44, the offset amount memory portion 54) stores the offset amount Zk being offset from zero, the offset amount Zk of the load detection device (the load detection device 10, the front load sensor 21F, the rear load sensor 21R), in response to the inclination angle of the vehicle detected by the inclination angle detection device (the G sensor 43).

The vehicle M for vacancy determination may be stopped on an inclined, or a tilted ground. For example, in a case where the load detection device 10 is placed in the front-rear direction of the center side of the vehicle M, which is the right-side of the left-side seat in the front-rear direction, the value detected by the load detection device 10 comes to be higher than a detected value of a flat ground without inclination when the vehicle M is in the stopped state in which the right-side of the vehicle M comes to be lower than the left-side of the vehicle M. On the other hand, the value detected by the load detection device 10 comes to be lower than the detected value of the flat ground without inclination when the vehicle M is in the stopped state in which the left-side of the vehicle M comes to be lower than the right-side of the vehicle M. Because the offset amount is obtained from the load value detected by the load detection device 10 in a state where the seat is vacant, the inclination of the ground where the vacant vehicle M is stopped is influential on the offset load value.

Accordingly, the G sensor 43 detects the inclination angle of the inclined ground on which the vehicle M is in the stopped state and the offset amount memory portion 54 stores the load value detected by the load detection device 10 as the offset amount Zk (for example, Zk7) which is in response to the inclination angle of the ground on which the vehicle M is in the stopped state, the inclination angle relative to a predetermined reference surface (which corresponds to a horizontal surface). Thus, not only a case where the vehicle M is in the stopped state on the horizontal ground but also a case where the vehicle M is stopped on the inclined ground, the offset amount Zk which corresponds to the inclination angle of the ground on which the vehicle M is stopped can be detected precisely. Because the load value detected by the load detection device 10 is corrected based on the precisely-detected offset amount Zk, the high-precision passenger determination is performed based on the load value detected by the load detection device 10.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A seat apparatus for a vehicle, comprising:
a seat;
an attachment member configured to be provided on a floor of the vehicle;
a fixing member provided at the seat to fix the seat to the attachment member;
a load detection device interposed between the fixing member and the attachment member, the load detection device measuring a load applied to the seat to distinguish an existence of a passenger and a type of a passenger;
an offset amount detection portion adding an offset amount being offset from zero, the offset amount of the load detection device occurred by a collision of the vehicle, to a value stored as an offset amount being offset from zero, the offset amount of the load detection device occurred before the collision of the vehicle, the offset amount detection portion storing the offset amount being offset from zero, the offset amount of the load detection device occurred by the collision of the vehicle and the value stored as the offset amount being offset from zero, the offset amount of the load detection device occurred before the collision of the vehicle as the offset amount being offset from zero, the offset amount of the load detection device, in a case where a collision load value occurred by the collision of the vehicle and detected by the load detection device exceeds a predetermined value; and
a correction portion correcting a load value detected by the load detection device on the basis of the offset amount being offset from zero, the offset amount of the load detection device stored in the offset amount detection portion.

2. The seat apparatus for the vehicle according to claim 1, wherein the collision load value that the load detection device detects at the collision of the vehicle corresponds to a load applied in a detachment direction, the detachment direction corresponding to a direction where the attachment member and the fixing member are separated from each other.

3. The seat apparatus for the vehicle according to claim 1, further comprising:
a correspondent relationship memory portion previously obtaining a relationship between the collision load value detected by the load detection device at a time of the collision of the vehicle and the offset amount being offset from zero, the offset amount occurred by the collision of the vehicle, and the correspondent relationship memory portion storing the relationship thereof; wherein
the offset amount detection portion detects the offset amount being offset from zero, the offset amount of the load detection device occurred by the collision of the vehicle, from the relationship stored in the correspondent relationship memory portion, the relationship between the collision load value and the offset amount being offset from zero, the offset amount occurred by the collision of the vehicle.

4. The seat apparatus for the vehicle according to claim 2, further comprising:
a correspondent relationship memory portion previously obtaining a relationship between the collision load value detected by the load detection device at a time of the collision of the vehicle and the offset amount being offset from zero, the offset amount occurred by the collision of the vehicle, and the correspondent relationship memory portion storing the relationship thereof; wherein
the offset amount detection portion detects the offset amount being offset from zero, the offset amount of the load detection device occurred by the collision of the vehicle, from the relationship stored in the correspondent relationship memory portion, the relationship between the collision load value and the offset amount being offset from zero, the offset amount occurred by the collision of the vehicle.

5. The seat apparatus for the vehicle according to either claim 3, further comprising:
a vacancy determination portion determining whether the seat is in a vacant state where the seat is neither occupied by a passenger nor by an object; wherein
the offset amount detection portion stores the collision load value detected by the load detection device as the offset amount being offset from zero, the offset amount of the load detection device, when the vacancy determination portion determines that the seat is in the vacant state.

6. The seat apparatus for the vehicle according to claim 4, further comprising:
a vehicle stop determination portion determining whether the vehicle is in a stopped state; wherein
the offset amount detection portion stores the collision load value detected by the load detection device as the offset amount being offset from zero, the offset amount of the load detection device, when the vehicle stop determination portion determines that the vehicle is in the stopped state.

7. The seat apparatus for the vehicle according to claim 6, further comprising:
an inclination angle detection device detecting an inclination angle of the vehicle relative to a predetermined reference surface in a case where the vehicle is in the stopped state; wherein
the offset amount detection portion stores the offset amount being offset from zero, the offset amount of the load detection device, in response to the inclination angle of the vehicle detected by the inclination angle detection device.
